(19) United States
(12) Patent Application Publication
(10) Pub. No.: US 2026/0045202 A1
(43) Pub. Date: Feb. 12, 2026

(54) DISPLAY DEVICE AND ELECTRONIC DEVICE

(71) Applicant: Samsung Display Co., LTD., Yongin-si (KR)

(72) Inventors: Minki Yang, Yongin-si (KR); Daehyun Kim, Yongin-si (KR); Sunghwan KIM, Yongin-si (KR); Kyoungjin PARK, Yongin-si (KR); Hyunae PARK, Yongin-si (KR); Hyeonjun Yoon, Yongin-si (KR); Changkyu JIN, Yongin-si (KR)

(21) Appl. No.: 19/078,635

(22) Filed: Mar. 13, 2025

(30) Foreign Application Priority Data
Aug. 7, 2024 (KR) 10-2024-0105196

(51) Int. Cl. G09G 3/32

(52) U.S. Cl. CPC G09G 3/32; G09G 2310/0267; G09G 2310/0275; G09G 2310/0291; G09G 2310/0297; G09G 2310/08; G09G 2330/021; G09G 2380/02

(57) ABSTRACT

A display device includes a display panel including a plurality of pixels, a gate driver which outputs a gate signal to the display panel, a data driver which generates a data voltage applied to the display panel and a mux block which outputs the data voltage to the display panel. The mux block includes an output control transistor including a control electrode receiving an output control signal, a first electrode connected to a first data line and a second electrode connected to a second data line.

This application claims priority to Korean Patent Application No. 10-2024-0105196, filed on Aug. 7 2024, and all the benefits accruing therefrom under 35 U.S.C. § 119, the content of which in its entirety is herein incorporated by reference.

### BACKGROUND

### 1. Field

Embodiments of the inventive concept relate to a display device, an electronic device. More particularly, embodiments of the inventive concept relate to a display device in which an integration is improved, and a power consumption is reduced.

### 2. Description of the Related Art

Generally, a display device includes a display panel and a display panel driver. The display panel includes a plurality of gate lines, a plurality of data lines, and a plurality of pixels. The display panel driver includes a gate driver providing a gate signal to the gate lines, a data driver providing a data voltage to the data lines, and a driving controller controlling the gate driver and the data driver.

Generally, a display device may include a multiplexer for selectively applying a data voltage to data lines.

### SUMMARY

Embodiments of the inventive concept provide a display device in which an integration is improved, and a power consumption is reduced.

Embodiments of the inventive concept also provide an electronic device in which an integration is improved, and a power consumption is reduced.

In an embodiment of the disclosure, a display device includes a display panel including a plurality of pixels, a gate driver which outputs a gate signal to the display panel, a data driver which generates a data voltage applied to the display panel and a mux block which outputs the data voltage to the display panel. The mux block includes an output control transistor including a control electrode receiving an output control signal, a first electrode connected to a first data line and a second electrode connected to a second data line.

In an embodiment, the data voltage may include a first data voltage and a second data voltage. The first data line may be connected to a first output amplifier of the data voltage.

The second data line may be connected to the first data line through the mux block.

In an embodiment, in a stated in which the output control signal has an activation level, the data driver may output the second data voltage.

In an embodiment, in a stated in which the output control signal has an inactivation level, the data driver may output the first data voltage.

In an embodiment, in a stated in which the output control signal has an inactivation level, the first data voltage may be applied to the first data line.

In an embodiment, a length of an activation period in which the output control signal has an activation level may be longer than a length of an inactivation period in which the output control signal has an inactivation level.

In an embodiment, the data driver may include a first output amplifier and a second output amplifier outputting the data voltage. The display panel may further include first to fourth data lines disposed sequentially. The mux block may further include a first output control transistor connected to the first data line and the second data line, and a second output control signal connected to the third data line and the fourth data line. The first output amplifier may be connected to the first data line. The second output amplifier may be connected to the third data line.

In an embodiment, the data driver may include a first output amplifier and a second output amplifier outputting the data voltage. The display panel may further include first to fourth data lines disposed sequentially. The mux block may further include a first output control transistor connected to the first data line and the second data line, and a second output control signal connected to the third data line and the fourth data line. The first output amplifier may be connected to the second data line. The second output amplifier may be connected to the fourth data line.

In an embodiment, the data voltage may include a first data voltage and a second data voltage. In a stated in which the output control signal has an activation level, the data driver may output the first data voltage.

In an embodiment, in a stated in which the output control signal has an inactivation level, the data driver may output the second data voltage.

In an embodiment, the data driver may be spaced apart from the display panel in a first positioning direction. The mux block may be spaced apart from the display panel in a second positioning direction different from the first positioning direction.

In an embodiment, the display panel may further include a fordable region and a non-folding region next (adjacent) to the fordable region. The mux block may be disposed on the fordable region.

In an embodiment, the non-folding region may include a first non-folding region and a second non-folding region. The first non-folding region may include a first data line group, and the second non-folding region includes a second data line group. The first data line group may be disposed next (adjacent) to the data driver. In a stated in which the output control signal has an activation level, the data voltage may be applied to the first data line group and the second data line group.

In an embodiment, in a stated in which the output control signal has an inactivation level, an operation in which the data voltage may be applied to the second data line group is stopped.

In an embodiment, the output control signal has an inactivation level, the second non-folding region may stop emitting.

In an embodiment, the display panel may further include first to fourth data line. The mux block may further include a first output control transistor connected to the first data line and the second data line, and a second output control transistor connected to the third data line and the fourth data line. A first color pixels having a first color and a second color pixels having a second color different from the first color may be connected to the first data line. A third color pixels having a third color different from the first color and the second color may be connected to the second data line. The first color pixels and the second color pixels may be connected to the third data line. The third color pixels may be connected to the fourth data line.

In an embodiment, the data driver may include a first output amplifier and a second output amplifier outputting the data voltage. The first output amplifier may be connected to the first data line and the second output amplifier is connected to the third data line. In a stated in which the output control signal has an inactivation level, the first output amplifier may output a first color data voltage, and the second output amplifier outputs a second color data voltage. In a stated in which the output control signal has an activation level, the first output amplifier and the second output amplifier may output a third color data voltage.

In an embodiment of the disclosure, an electronic device includes a display panel including a plurality of pixels, a gate driver which outputs a gate signal to the display panel, a data driver which generates a data voltage applied to the display panel, a mux block which outputs the data voltage to the display panel and a processor which controls the gate driver, the data driver and the mux block. The mux block includes a first output control transistor including a control electrode receiving a second output control signal, a first electrode connected to a first output line and a second electrode connected to a first data line and a second output control transistor including a control electrode receiving a first output control signal, a first electrode connected to the first output line and a second electrode connected to a second data line. The data driver may be spaced apart from the display panel in a first positioning direction. The mux block may be spaced apart from the display panel in a second positioning direction different from the first positioning direction.

In an embodiment, the data voltage may include a first data voltage and a second data voltage. A period in which the data voltage is applied may include a first period and a second period. In the first period, the data voltage may have the second data voltage, the first output control signal may have an activation level, the second output control signal may have an inactivation level, and the second data voltage may be applied to the second data line.

In an embodiment, in the second period, the data voltage may have the first data voltage, the first output control signal may have an inactivation level, the second output control signal may have an activation level, and the first data voltage may be applied to the first data line.

As described above, a data driver may be spaced apart from a display panel in a first positioning direction, and a mux block may be spaced apart from a display panel in a second positioning direction, so that a bezel of a display device may be reduced. For example, a bezel of a bottom region of the display device may be reduced.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating an embodiment of a display device according to the inventive concept.

FIG. 2 is a block diagram illustrating an embodiment of a location of display device of FIG. 1.

FIG. 3 is a block diagram illustrating an embodiment of an output control transistor included in a mux block of FIG. 2.

FIG. 4 is a circuit diagram illustrating an embodiment of a display panel, a data driver and a mux block of FIG. 3.

FIG. 5 is a timing diagram illustrating input signals in an active period of a display device of FIG. 1.

FIG. 6 is a timing diagram illustrating an embodiment of input signals in an activation period and an inactivation period included in a scan period of FIG. 5.

FIG. 7 is a timing diagram illustrating an embodiment of input signals in an activation period and an inactivation period included in a scan period of FIG. 5.

FIG. 8 is a circuit diagram illustrating an embodiment of a display panel, a data driver and a mux block of FIG. 3.

FIG. 9 is a timing diagram illustrating input signals in an active period of a display device of FIG. 1.

FIG. 10 is a circuit diagram illustrating an embodiment of a display panel, a data driver and a mux block of FIG. 3.

FIG. 11 is a timing diagram illustrating input signals in an active period of a display device of FIG. 1.

FIG. 12 is a perspective view illustrating an embodiment of a display device.

FIG. 13 is a side view illustrating an embodiment of a folded state of the display device taken along line I-I′ of FIG. 12.

FIG. 14 is a side view illustrating an embodiment of a location of a data driver and a mux block included in a display device taken along line I-I′ of FIG. 12.

FIG. 15 is a circuit diagram illustrating an embodiment of a location of a display panel and a data driver of FIG. 1 and a mux block.

FIG. 16 is a circuit diagram illustrating an embodiment of a location of a display panel and a data driver of FIG. 1 and a mux block.

FIG. 17 is a block diagram illustrating an embodiment of a location of a display device of FIG. 1.

FIG. 18 is a circuit diagram illustrating an embodiment of a display panel, a data driver and a mux block of FIG. 17.

FIG. 19 is a timing diagram illustrating input signals in an active period of a display device of FIG. 1.

FIG. 20 is a timing diagram illustrating an embodiment of input signals in an activation period and an inactivation period included in a scan period of FIG. 19.

FIG. 21 is a circuit diagram illustrating an embodiment of a location of a display panel and a data driver of FIG. 1 and a mux block.

FIG. 22 is a block diagram illustrating an electronic device according to the inventive concept.

### DETAILED DESCRIPTION OF THE INVENTIVE CONCEPT

Hereinafter, the inventive concept will be explained in detail with reference to the accompanying drawings.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” may therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” may, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

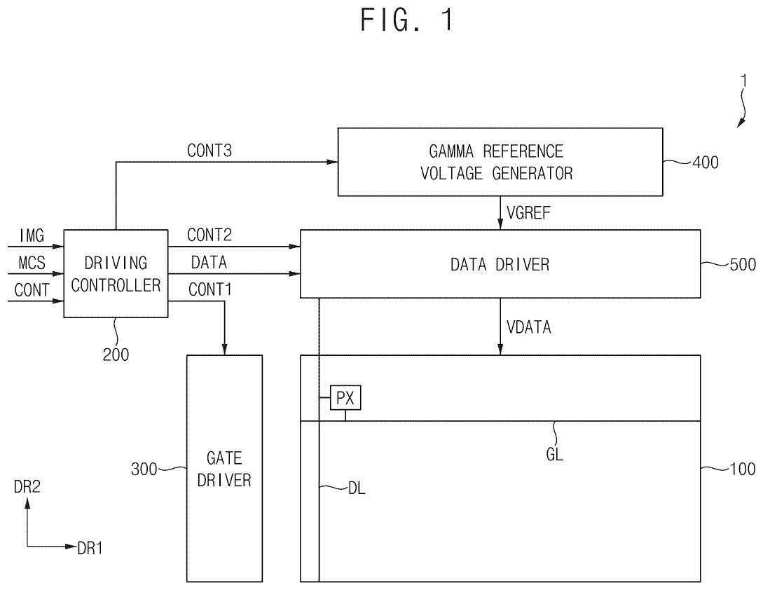

FIG. 1 is a block diagram illustrating an embodiment of a display device 1 according to the inventive concept.

Referring to FIG. 1, the display device 1 may include a display panel 100 and a display panel driver. The display panel driver may include a driving controller 200, a gate emission driver 300, a gamma reference voltage generator 400 and a data driver 500. In an embodiment, the display device 1 may further include a mux block.

The display panel 100 may have a display region on which an image is displayed and a peripheral region next (adjacent) to the display region.

The display panel 100 may include a plurality of gate lines GL, a plurality of data lines DL and a plurality of pixels PX electrically connected to the gate lines GL and the data lines DL. The gate lines GL may extend in a first direction DR1 and the data lines DL may extend in a second direction DR2 crossing the first direction DR1.

The driving controller 200 may receive input image data IMG, an input control signal CONT and a mux control signal MCS from an external device. In an embodiment, the input image data IMG may include red image data, green image data and blue image data, for example. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal. The driving controller 200 may control a mux block based on the mux control signal MCS.

The driving controller 200 may generate a first control signal CONT1, a second control signal CONT2, a third control signal CONT3 and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The gate driver 300 may generate gate signals driving the gate lines GL in response to the first control signal CONT1 received from the driving controller 200. The gate driver 300 may output the gate signals to the gate lines GL.

In an embodiment, the gate driver 300 may be disposed in the peripheral region. In an embodiment, the gate driver 300 may be integrated in the peripheral region.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages VDATA having an analog type using the gamma reference voltages VGREF. The data driver 500 outputs the data voltages VDATA to the data lines DL. In an embodiment, the data driver 500 may further output a pulse data voltage PWVDATA. In an embodiment, the data driver 500 may generate a data current based on the data signal DATA.

In an embodiment, the data driver 500 may be disposed in the peripheral region. In an embodiment, the data driver 500 may be integrated in the peripheral region.

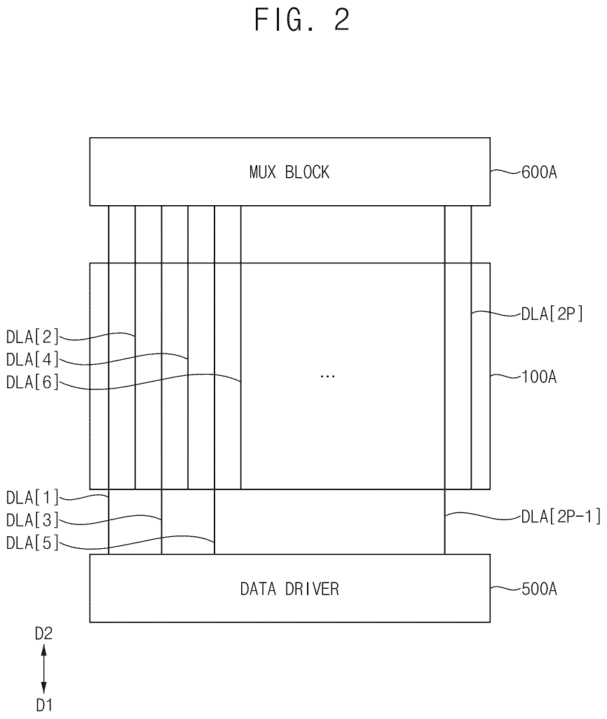

FIG. 2 is a block diagram illustrating an embodiment of a location of display device 1 of FIG. 1.

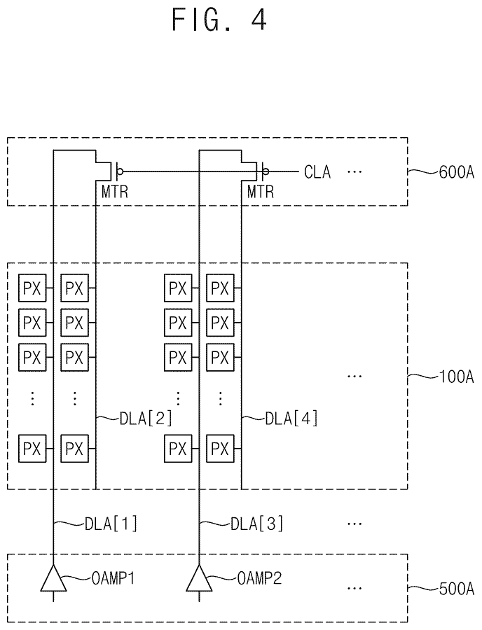

Referring to FIG. 1 and FIG. 2, the display device 1 may include a display panel 100A, a data driver 500A and a mux block 600A. The display panel 100A first to 2P data lines DLA[1], DLA[2], DLA[3], DLA[4], DLA[5], DLA[6] to DLA[2P-1] and DLA[2P]. In an embodiment, the data driver 500A may be connected to the mux block 600A through odd-numbered data lines DLA[1], DLA[3], DLA[5] . . . DLA[2P-1], for example. When the data driver 500A is connected to the mux block 600A through odd-numbered data lines DLA[1], DLA[3], DLA[5] . . . DLA[2P-1], even-numbered data lines DLA[2], DLA[4], DLA[6] . . . DLA[2P] may not be connected to output amplifiers OMP1 and OMP2. In an embodiment, the data driver 500A may be connected to the mux block 600A through even-numbered data lines DLA[1], DLA[3], DLA[5] . . . DLA[2P-1], for example. When the data driver 500A is connected to the mux block 600A through the even-numbered data lines DLA[2], DLA[4], DLA[6] . . . DLA[2P], the odd-numbered data lines DLA[1], DLA[3], DLA[5] . . . DLA[2P-1] may not be connected to output amplifiers OMP1 and OMP2 of FIG. 4.

In the illustrated embodiment, the data driver 500A may be spaced apart from the display panel 100A in a first positioning direction D1. Additionally, the mux block 600A may be spaced apart from the display panel 100A in a second positioning direction D2. In an embodiment, the first positioning direction D1 and the second positioning direction D2 may be opposite to each other in the second direction DR2, but is not limited thereto, and may be opposite to each other in another direction. In an embodiment, the data driver 500A may be disposed on a bottom region of the display panel 100A, for example. In an embodiment, the mux block 600A may be upper region of the display panel 100A, for example. The data driver 500A may be spaced apart from the display panel 100A in the first positioning direction D1, and the mux block 600A may be spaced apart from the display panel 100A in the second positioning direction D2, so that a bezel of the display device 1 may be reduced. In an embodiment, a bezel of the bottom region of the display device 1 may be reduced, for example.

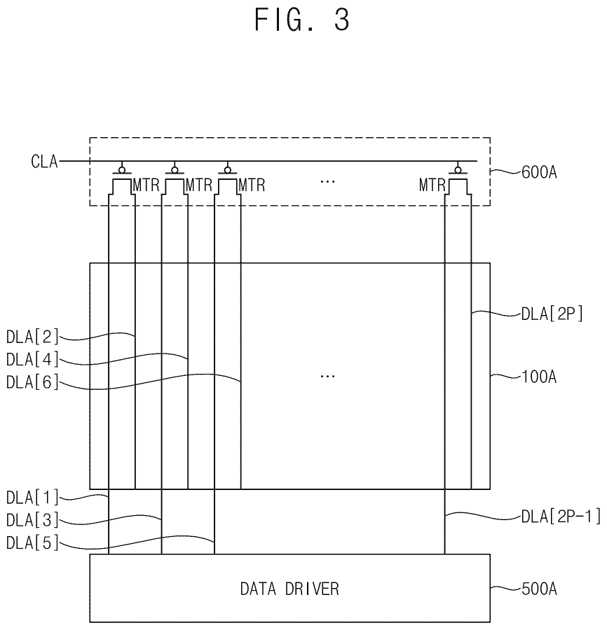

FIG. 3 is a block diagram illustrating an embodiment of an output control transistor MTR included in a mux block 600A of FIG. 2.

Referring to FIG. 1 to FIG. 3, the mux block 600A may include an output control transistor MTR. The mux block 600A may include a plurality of the output control transistors MTR. In an embodiment, when the number of the data lines DL included in the display panel 100A is 2P where P is positive integer, the mux block 600A may include P output control transistors MTR, for example. However, the inventive concept is not limited to the number of the output control transistors MTR.

The output control transistor MTR may include a control electrode receiving an output control signal CLA, a first electrode connected to an odd-numbered data line and a second electrode connected to an even-numbered data line. The output control transistor MTR may connect the odd-numbered data line and the even-numbered data line in response to the output control signal CLA.

In an embodiment, the mux block 600A may include first to P-th output control transistors, for example.

The first output control transistor may include a control electrode receiving an output control signal CLA, a first electrode connected to the first data line DLA[1] and a second electrode connected to the second data line DLA[2]. The second output control transistor may include a control electrode receiving an output control signal CLA, a first electrode connected to the third data line DLA[3] and a second electrode connected to the fourth data line DLA[4]. The third output control transistor may include a control electrode receiving an output control signal CLA, a first electrode connected to the fifth data line DLA[5] and a second electrode connected to the sixth data line DLA[6]. The P-th output control transistor may include a control electrode receiving an output control signal CLA, a first electrode connected to the 2P-1-th data line DLA[2P-1] and a second electrode connected to the 2P-th data line DLA[2P].

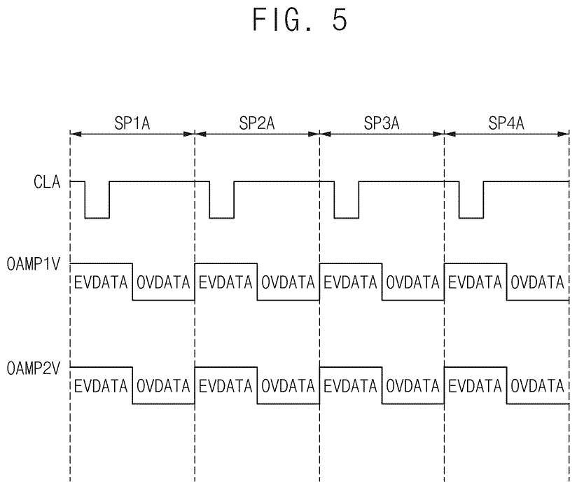

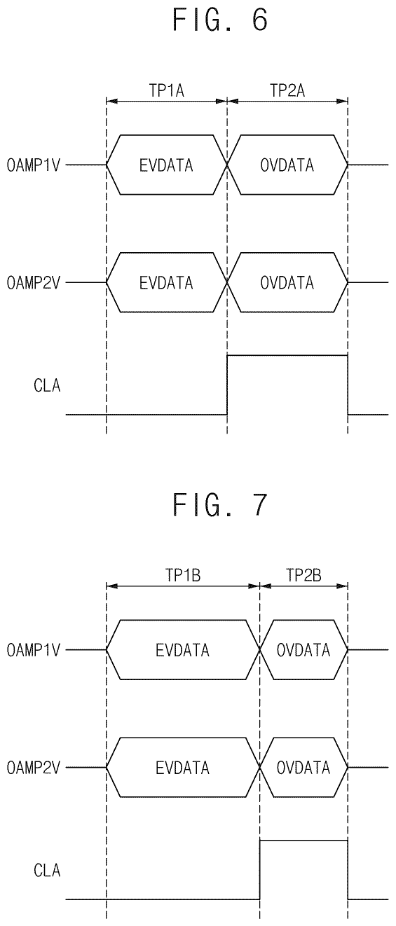

FIG. 4 is a circuit diagram illustrating an embodiment of a display panel 100A, a data driver 500A and a mux block 600A of FIG. 3. FIG. 5 is a timing diagram illustrating input signals in an active period of a display device 1 of FIG. 1. FIG. 6 is a timing diagram illustrating an embodiment of input signals in an activation period and an inactivation period included in a scan period of FIG. 5.

Referring to FIG. 1 to FIG. 6, the data driver 500A may include the output amplifiers OAMP1 and OAMP2. The output amplifiers OAMP1 and OAMP2 may output the data voltage VDATA. The data voltage VDATA may include an odd-numbered data voltage OVDATA and an even-numbered data voltage EVDATA. In an embodiment, the odd-numbered data voltage OVDATA may be referred to as a first data voltage, for example. In an embodiment, the even-numbered data voltage EVDATA may be referred to as a second data voltage, for example.

The first data line DLA[1] may be connected to a first pixel-column. The second data line DLA[2] may be connected to a second pixel-column. The third data line DLA[3] may be connected to a third pixel-column. The fourth data line DLA[4] may be connected to a fourth pixel-column.

In the illustrated embodiment, in an active period, the data voltage VDATA may be applied to the pixel circuit of the pixel PX. In an embodiment, the active period may include a first scan period SP1A, a second scan period SP2A, a third scan period SP3A and a fourth scan period SP4A, for example. Each of the first scan period SP1A, the second scan period SP2A, the third scan period SP3A and the fourth scan period SP4A may include an activation period and an inactivation period. In the activation period, the output control signal CLA may have an activation level. In the inactivation period, the output control signal CAS may have an inactivation level.

In an embodiment, in the first scan period SP1A, the data voltage VDATA may be applied to a first pixel-row, for example. In the second scan period SP2A, the data voltage VDATA may be applied to a second pixel-row. In the third scan period SP3A, the data voltage VDATA may be applied to a third pixel-row. In the fourth scan period SP4A, the data voltage VDATA may be applied to a fourth pixel-row.

In the illustrated embodiment, the first output amplifier OAMP1 may be connected to the first data line DLA[1]. The second output amplifier OMP2 may be connected to the third data line DLA[3]. In an embodiment, the output amplifiers OAMP1 and OAMP2 may be connected to the odd-numbered data lines DLA[1], DLA[3], DLA[5] . . . DLA[2P-1], for example. The output amplifiers OAMP1 and OAMP2 may output the odd-numbered data voltage OVDATA and the even-numbered data voltage EVDATA. In an embodiment, a voltage outputted from the first output amplifier OAMP1 may be referred to as a first output amplified voltage OAMP1V, for example. In an embodiment, a voltage outputted from the second output amplifier OAMP2 may be referred to as a second output amplified voltage OAMP2V, for example.

In the illustrated embodiment, the first period TP1A may be the activation period. In the first period TP1A, the data voltage VDATA may have the even-numbered data voltage EVDATA. In the first period TP1A, the output amplifiers OAMP1 and OAMP2 may output the even-numbered data voltage EVDATA, and the output control signal CLA may have an activation level.

In the first period TP1A, the output control signal CLA may have an activation level, so that the output control transistor MTR may be turned on. The first output control transistor may be turned on, so that the even-numbered data voltage EVDATA may be applied to the first data line DLA[1] and the second data line DLA[2]. The second output control transistor may be turned on, so that the even-numbered data voltage EVDATA may be applied to the third data line DLA[3] and the fourth data line DLA[4]. In an embodiment, the even-numbered data voltage EVDATA may be applied to the odd-numbered data lines DLA[1], DLA[3], DLA[5] . . . DLA[2P-1] and the even-numbered data lines DLA[2], DLA[4], DLA[6] . . . DLA[2P], for example. In an embodiment, the even-numbered data voltage EVDATA may be applied to odd-numbered pixel-rows and even-numbered pixel-rows, for example.

In the illustrated embodiment, the second period TP2A may be the inactivation period. In the second period TP2A, the data voltage VDATA may have the odd-numbered data voltage OVDATA. In the second period TP2A, the output amplifiers OAMP1 and OAMP2 may output the odd-numbered data voltage OVDATA, and the output control signal CLA may have an inactivation level.

In the second period TP2A, the output control signal CLA may have an inactivation level, so that the output control transistor MTR may be turned off. In the second period TP2A, the odd-numbered data voltage OVDATA may be applied to the first data line DLA[1]. The first output control transistor may be turned off, so that the first data line DLA[1] and the second data line DLA[2] may not be connected. The first data line DLA[1] and the second data line DLA[2] may not be connected, the odd-numbered data voltage OVDATA may not be applied to the second data line DLA[2]. Accordingly, the second pixel-column may maintain the even-numbered data voltage EVDATA. Additionally, the odd-numbered data voltage OVDATA may be applied to the first pixel-column. In the second period TP2A, the odd-numbered data voltage OVDATA may be applied to the third data line DLA[3]. The second output control transistor may be turned off, so that the third data line DLA[3] and the fourth data line DLA[4] may not be connected. The third data line DLA[3] and the fourth data line DLA[4] may not be connected, the odd-numbered data voltage OVDATA may not be applied to the fourth data line DLA[4]. Accordingly, the fourth pixel-column may maintain the even-numbered data voltage EVDATA. Additionally, the odd-numbered data voltage OVDATA may be applied to the third pixel-column. In an embodiment, the odd-numbered data voltage OVDATA may be applied to the odd-numbered pixel-columns, for example. Additionally, the odd-numbered data voltage OVDATA may not be applied to the even data lines DLA[2], DLA[4], DLA[6] . . . DLA[2P]. In an embodiment, the odd-numbered pixel-columns may maintain the even-numbered data voltage EVDATA, for example.

In the illustrated embodiment, the data voltage VDATA applied to the first data line DLA[1] and the second data line DLA[2] may be selected through the first output control transistor. In an embodiment, a data voltage applied to two data lines may be controlled through one transistor, for example. Accordingly, the number of output control transistors included in the mux block 600A may be reduced. The number of output control transistors included in the mux block 600A may be reduced, so that an integration of the mux block 600A may be improved. Accordingly, an integration of the display device 1 may be improved. Additionally, the number of output control transistors included in the mux block 600A may be reduced, so that a power consumption of the display device 1 may be reduced.

FIG. 7 is a timing diagram illustrating an embodiment of input signals in an activation period and an inactivation period included in a scan period of FIG. 5.

Referring to FIG. 7, a scan period may include a first period TP1B and a second period TP2B. The first period TP1B may be the activation period. The second period TP2B may be the inactivation period.

A timing diagram of FIG. 7 is substantially same as a timing diagram of FIG. 6 except that a length of the first period TP1B is different from a length of the second period TP2B, so that the same reference numerals will be used and any repetitive explanation concerning the above elements will be omitted.

Referring to FIG. 1 to FIG. 5 and FIG. 7, in the illustrated embodiment, the length of the first period TP1B may be different from the length of the second period TP2B. In an embodiment, the length of the first period TP1B may be longer than the length of the second period TP2B, for example. Accordingly, a length of a period in which the even-numbered data voltage EVDATA is applied to the even-numbered data lines DLA[2], DLA[4], DLA[6] . . . DLA[2P] may be increased. In an embodiment, the even-numbered data voltage EVDATA may be applied to the even-numbered data lines DLA[2], DLA[4], DLA[6] . . . DLA[2P] through the odd-numbered data lines DLA[1], DLA[3], DLA[5] . . . DLA[2P-1], for example. The length of the period in which the even-numbered data voltage EVDATA is applied to the even-numbered data lines DLA[2], DLA[4], DLA[6] . . . DLA[2P] may be increased, so that an influence of the odd-numbered data lines DLA[1], DLA[3], DLA[5] . . . DLA[2P-1] may be reduced. In an embodiment, an influence of a resistance of the odd-numbered data lines DLA[1], DLA[3], DLA[5] . . . DLA[2P-1] may be reduced, for example. Accordingly, a reliability of the even-numbered data voltage EVDATA applied to the even-numbered pixel-columns may be improved. Accordingly, an emission reliability of the pixel circuit of the pixel PX may be improved.

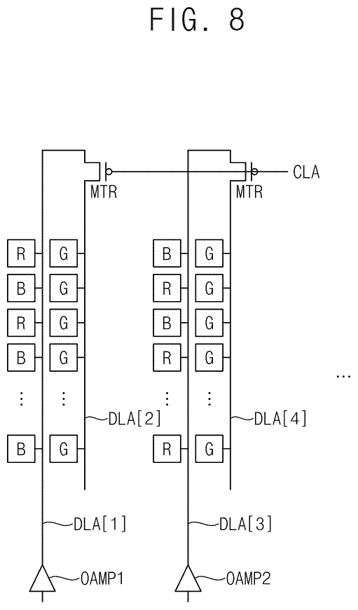

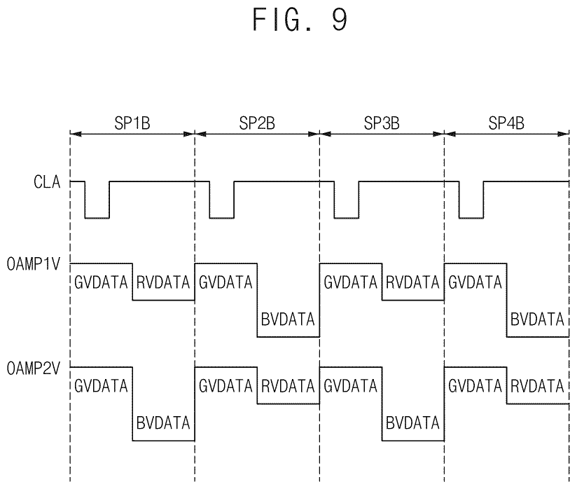

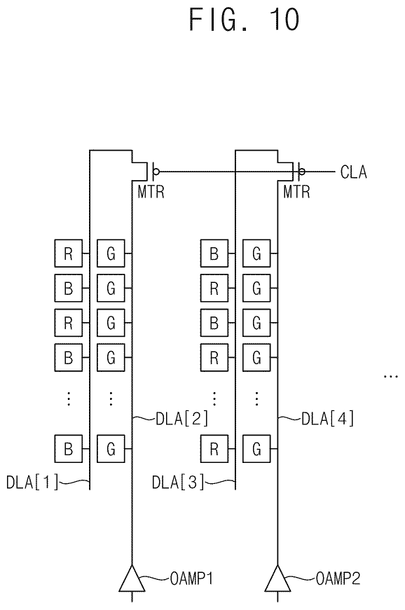

FIG. 8 is a circuit diagram illustrating an embodiment of a display panel 100A, a data driver 500A and a mux block 600A of FIG. 3. FIG. 9 is a timing diagram illustrating input signals in an active period of a display device 1 of FIG. 1.

Referring to FIG. 1 to FIG. 9, in the illustrated embodiment, the odd-numbered data lines DLA[1], DLA[3], DLA[5] . . . DLA[2P-1] may be connected to a first color pixel R and a second color pixel B. In an embodiment, the first color pixel may have a first color. The second color pixel B may have a second color different from the first color, for example. In an embodiment, the first color may be red, for example. In an embodiment, the second color may be blue. In an embodiment, the first color pixel R and the second color pixel B may be alternately disposed on the odd-numbered data lines DLA[1], DLA[3], DLA[5] . . . DLA[2P-1], for example. In an embodiment, the first color pixel R and the second color pixel B may be alternately disposed on the first data line DLA[1], for example. In an embodiment, the second color pixel B and the first color pixel R may be alternately disposed on the third data line DLA[3], for example. The even-numbered data lines DLA[2], DLA[4], DLA[6] . . . DLA[2P] may be connected to a third color pixel G. In an embodiment, the third color pixel G may have a third color different from the first color and the second color, for example. In an embodiment, the third color may be green, for example. In an embodiment, the display panel 100A may have a pentile structure, for example.

In the illustrated embodiment, the data voltage VDATA may be applied to the pixel circuit of the pixel PX in scan periods SP1B, SP2B, SP3B and SP4B. The data voltage VDATA may include a first color data voltage RVDATA, a second color data voltage BVDATA and a third color data voltage GVDATA.

In the activation period of the first scan period SP1B, the output amplifiers OAMP1 and OAMP2 may output the third color data voltage GVDATA. Accordingly, the third color pixel G may receive the third color data voltage GVDATA. In the inactivation period of the first scan period SP1B, the first output amplifier OAMP1 may output the first color data voltage RVDATA, and the second output amplifier OAMP2 may output the second color data voltage BVDATA. Accordingly, the first color pixels R may receive the first color data voltage RVDATA, and the second color pixels B may receive the second color data voltage BVDATA. In the inactivation period of the first scan period SP1B, the output control transistors MTR may be turned off, so that the third color pixels G may maintain the third color data voltage GVDATA.

In the activation period of the second scan period SP2B, the output amplifiers OAMP1 and OAMP2 may output the third color data voltage GVDATA. Accordingly, the third color pixel G may receive the third color data voltage GVDATA. In the inactivation period of the second scan period SP2B, the first output amplifier OAMP1 may output the second color data voltage BVDATA, and the second output amplifier OAMP2 may output the first color data voltage RVDATA. Accordingly, the first color pixels R may receive the first color data voltage RVDATA, and the second color pixels B may receive the second color data voltage BVDATA. In the inactivation period of the second scan period SP2B, the output control transistors MTR may be turned off, so that the third color pixels G may maintain the third color data voltage GVDATA.

In the illustrated embodiment, the data voltage VDATA applied to the first data line DLA[1] and the second data line DLA[2] may be selected through the first output control transistor. In an embodiment, a data voltage applied to two data lines may be controlled through one transistor, for example. Accordingly, the number of output control transistors included in the mux block 600A may be reduced. The number of output control transistors included in the mux block 600A may be reduced, so that an integration of the mux block 600A may be improved. Accordingly, an integration of the display device 1 may be improved. Additionally, the number of output control transistors included in the mux block 600A may be reduced, so that a power consumption of the display device 1 may be reduced.

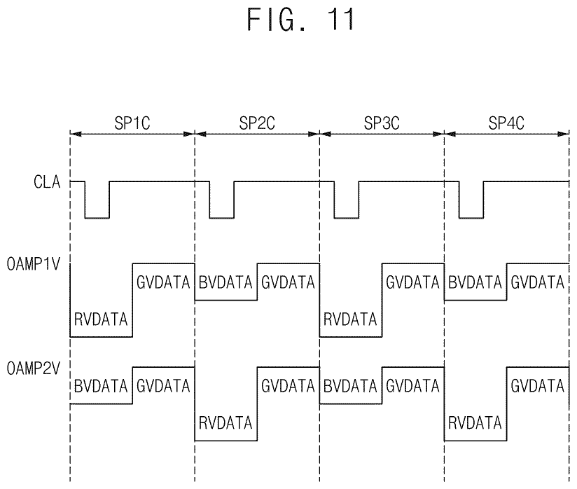

FIG. 10 is a circuit diagram illustrating an embodiment of a display panel 100A, a data driver 500A and a mux block 600A of FIG. 3. FIG. 11 is a timing diagram illustrating input signals in an active period of a display device 1 of FIG. 1.

Referring to FIG. 10, a circuit diagram of FIG. 10 is substantially same as a circuit diagram of FIG. 8 except that the output amplifiers OAMP1 and OAMP2 may be connected to the even-numbered data lines DLA[2], DLA[4], DLA[6] . . . DLA[2P], so that the same reference numerals will be used and any repetitive explanation concerning the above elements will be omitted.

Referring to FIG. 1 to FIG. 7, FIG. 10 and FIG. 11, the output amplifiers OAMP1 and OAMP2 may be connected to the even-numbered data lines DLA[2], DLA[4], DLA[6] . . . DLA[2P]. Additionally, the data voltage VDATA may be applied to the pixel circuit of the pixel PX in scan periods SP1C, SP2C, SP3C and SP4C.

In the activation period of the first scan period SP1C, the first output amplifier OAMP1 may output the first color data voltage RVDATA, and the second output amplifier OAMP2 may output the second color data voltage BVDATA. Accordingly, the first color pixels R may receive the first color data voltage RVDATA, and the second color pixels B may receive the second color data voltage BVDATA. In the inactivation period of the first scan period SP1C, the output amplifiers OAMP1 and OAMP2 may output the third color data voltage GVDATA. Accordingly, the third color pixel G may receive the third color data voltage GVDATA. In the inactivation period of the first scan period SP1C, the output control transistors MTR may be turned off, so that the first color pixels R may maintain the first color data voltage RVDATA, and the second color pixels B may maintain the second color data voltage BVDATA.

In the activation period of the second scan period SP2C, the first output amplifier OAMP1 may output the second color data voltage BVDATA, and the second output amplifier OAMP2 may output the first color data voltage RVDATA. Accordingly, the first color pixels R may receive the first color data voltage RVDATA, and the second color pixels B may receive the second color data voltage BVDATA. In the inactivation period of the second scan period SP2C, the output amplifiers OAMP1 and OAMP2 may output the third color data voltage GVDATA. Accordingly, the third color pixel G may receive the third color data voltage GVDATA. In the inactivation period of the second scan period SP2C, the output control transistors MTR may be turned off, so that the first color pixels R may maintain the first color data voltage RVDATA, and the second color pixels B may maintain the second color data voltage BVDATA.

In the illustrated embodiment, the data voltage VDATA applied to the first data line DLA[1] and the second data line DLA[2] may be selected through the first output control transistor. In an embodiment, a data voltage applied to two data lines may be controlled through one transistor, for example. Accordingly, the number of output control transistors included in the mux block 600A may be reduced. The number of output control transistors included in the mux block 600A may be reduced, so that an integration of the mux block 600A may be improved. Accordingly, an integration of the display device 1 may be improved. Additionally, the number of output control transistors included in the mux block 600A may be reduced, so that a power consumption of the display device 1 may be reduced.

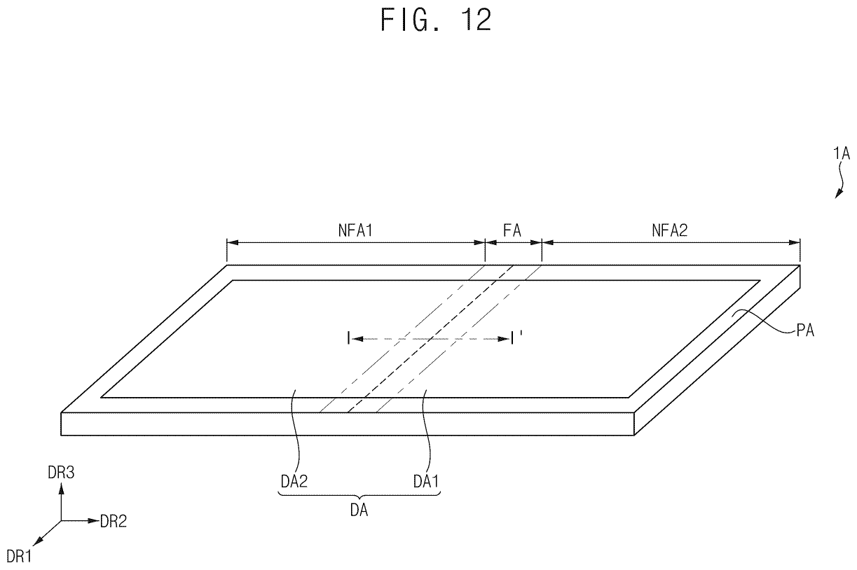

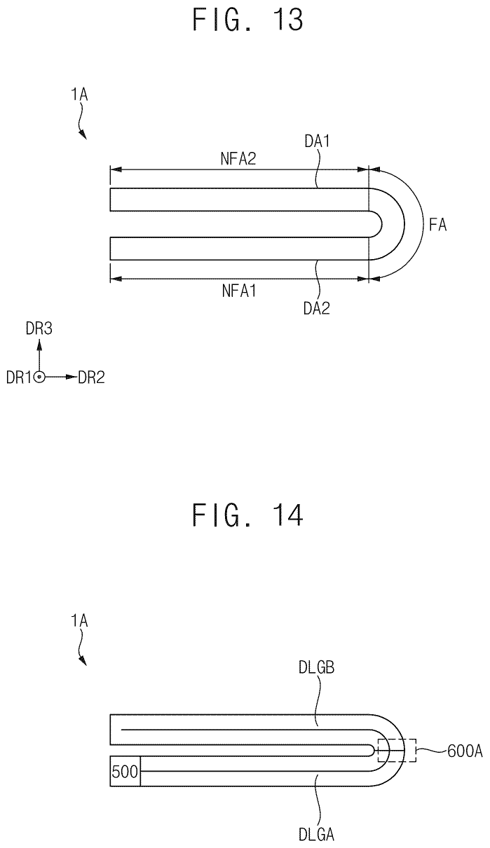

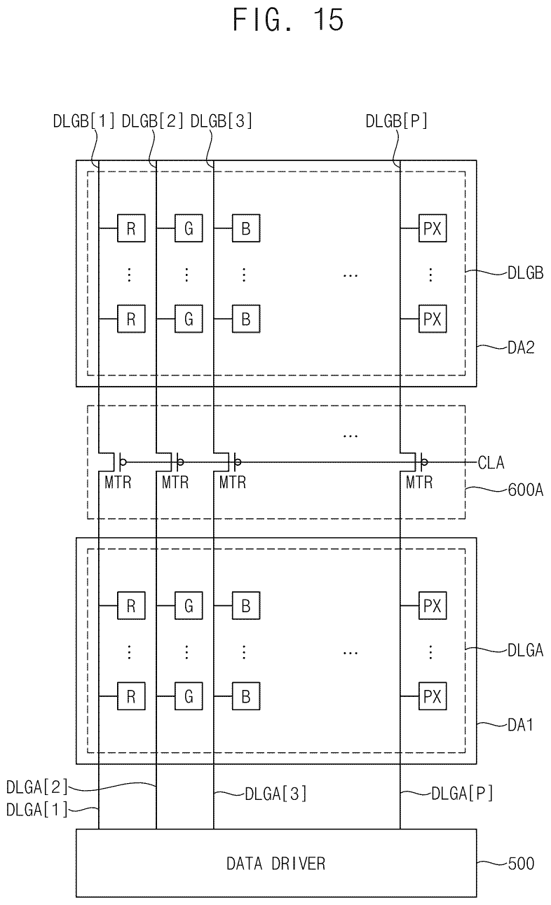

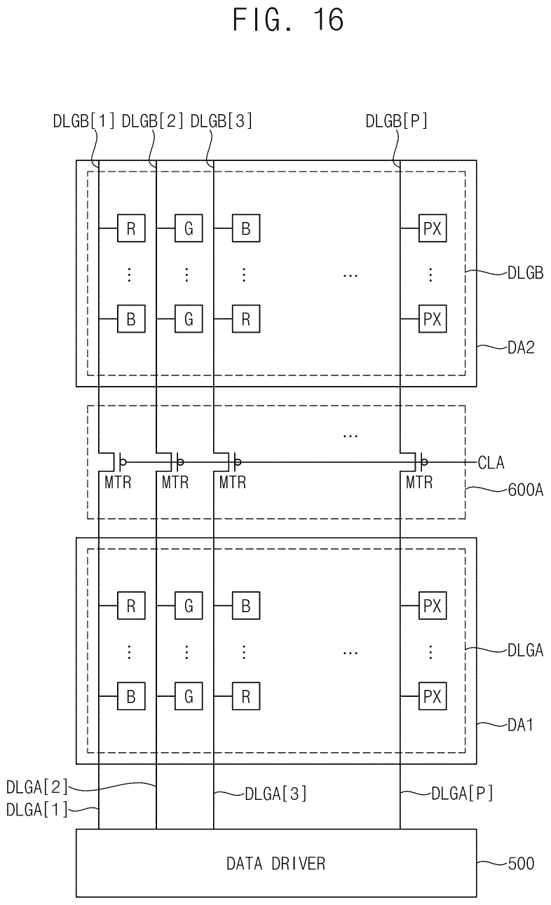

FIG. 12 is a perspective view illustrating an embodiment of a display device. FIG. 13 is a side view illustrating an embodiment of a folded state of the display device taken along line I-I′ of FIG. 12. FIG. 14 is a side view illustrating an embodiment of a location of a data driver 500 and a mux block 600A included in a display device 1A taken along line I-I′ of FIG. 12. FIG. 15 is a circuit diagram illustrating an embodiment of a location of a display panel 100 and a data driver 500 of FIG. 1 and a mux block 600A. FIG. 16 is a circuit diagram illustrating an embodiment of a location of a display panel 100 and a data driver 500 of FIG. 1 and a mux block 600A.

Referring to FIG. 1 to FIG. 16, a display device 1A may include a display region DA and a peripheral region PA. The display region DA may display the image. The peripheral region PA may not display the image. The peripheral region PA may be disposed next (adjacent) to the display region DA.

In this specification, a plane may be defined in a first direction DR1 and a second direction DR2. In an embodiment, the second direction DR2 may be perpendicular to the first direction DR1. In addition, a third direction DR3 may be perpendicular to the plane, for example.

The display device 100 includes a foldable region FA that may be bent by an external force so that the display device 100 may be folded, and first and second non-folding region NFA and NFA2 not folded and next (adjacent) to at least one side of the foldable region FA. The foldable region FA and the first and second non-folding region NFA1 and NFA2 may at least overlap the display region DA. In an embodiment, the foldable region FA may have a folding axis extending along the first direction DR1, for example.

The display region DA may be divided into a first display region DA1 and a second display region DA2 next (adjacent) to each other in the second direction DR2 that intersects the first direction DR2. In an embodiment, the second direction DR2 may intersect the first direction DR1, for example. The first display region DA1 and the second display region DA2 may be continuously connected to substantially form one display region DA. In an embodiment, when the display region DA is folded along the folding axis, as shown in FIG. 2, the display device may have an in-folded structure so that the first display region DA1 and the second display region DA2 face each other, for example. In an alternative embodiment, when the display region DA is folded along the folding axis, as shown in FIG. 3, the display device may have an out-folded structure in which the display region DA is disposed on the outside.

The display device 100 in an embodiment of the disclosure is not limited to including one foldable region FA. In an embodiment, the display device 100 may be folded multiple times or may have a plurality of foldable regions FA to implement a rollable display device 100, for example.

In the illustrated embodiment, the data driver 500 may be locate on the peripheral region PA. The mux block 600A may be disposed in the foldable region FA. The first display region DA1 may include a first data line group DLGA. The second display region DA2 may include a second data line group DLGB. The data driver 500 may be connected to the second data line group DLGB through the mux block 600A. The first data line group DLGA may include a first-first data line DLGA[1], a first-second data line DLGA[2], a first-third data line DLGA[3] . . . a first-P-th data line DLGA[P]. The second data line group DLGB may include a second-first data line DLGB[1], a second-second data line DLGB[2], a second-third data line DLGB[3] . . . a second-P-th data line DLGB[P]. The first-first data line DLGA[1] may be connected to the second-first data line DLGB[1] through an output control transistor MTR. The first-second data line DLGA[2] may be connected to the second-second data line DLGB[2] through the output control transistor MTR. The first-third data line DLGA[3] may be connected to the second-third data line DLGB[3] through the output control transistor MTR. The first-P-th data line DLGA[P] may be connected to the second-P-th data line DLGB[P] through the output control transistor MTR.

In an embodiment, first color pixels R may be connected to the first-first data line DLGA[1] and the second-first data line DLGB[1]. The third color pixels G may be connected to the first-second data line DLGA[2] and the second-second data line DLGB[2]. The second color pixels B may be connected to the first-third data line DLGA[3] and the second-third data line DLGB[3].

In an embodiment, the first color pixels R and the second color pixels B may be connected to the first-first data line DLGA[1] and the second-first data line DLGB[1]. In an embodiment, the first color pixels R and the second color pixels B may be alternately connected to the first-first data line DLGA[1] and the second-first data line DLGB[1], for example. The third color pixels G may be connected to the first-second data line DLGA[2] and the second-second data line DLGB[2]. The first color pixels R and the second color pixels B may be connected to the first-third data line DLGA[3] and the second-third data line DLGB[3]. The first color pixels R and the second color pixels B may be alternately connected to the first-third data line DLGA[3] and the second-third data line DLGB[3].

In an embodiment, when the first display region DA1 and the second display region DA2 emit light, the output control signal CLA may have an activation level, for example. Accordingly, the output control transistor MTR included in the mux block 600A may be turned on. The output control transistor MTR may be turned on, so that the first data line group DLGA and the second data line group DLGB may be connected. Accordingly, the data driver 500 may apply the data voltage VDATA to the second data line group DLGB through the first data line group DLGA and the mux block 600A. Accordingly, the data voltage VDATA may be applied to the second data line group DLGB. The data voltage VDATA may be applied to the second data line group DLGB, so that the pixel circuit of the pixel PX connected to the second data line group DLGB may emit light based on the data voltage VDATA.

In an embodiment, when the first display region DA1 emits light, and the second display region DA2 stops emitting, the output control signal CLA may have an inactivation level, for example. Accordingly, the output control transistor MTR included in the mux block 600A may be turned off. Accordingly, the first data line group DLGA and the second data line group DLGB may not be connected. The first data line group DLGA and the second data line group DLGB may not be connected, so that the data voltage VDATA may not be applied to the second data line group DLGB. In an embodiment, when the output control signal CLA has an inactivation level, an operation in which the data voltage VDATA is applied to the second data line group DLGB may not be performed, for example. Accordingly, the second display region DA2 may stop emitting.

In the illustrated embodiment, an emission operation of the first display region DA1 and an emission operation of the second display region DA2 may be controlled through the mux block 600A. In an embodiment, the data voltage VDATA applied to the second display region DA2 may be controlled through the mux block 600A, for example. Accordingly, a power consumption of the display device 1A may be reduced.

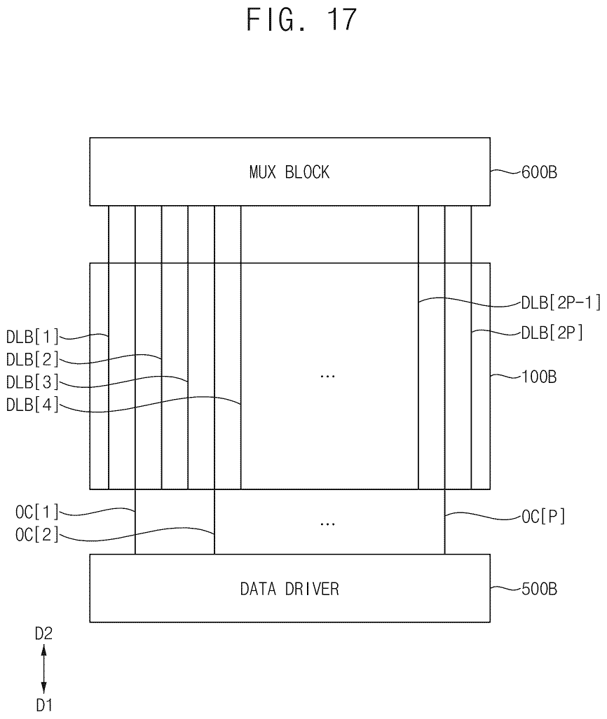

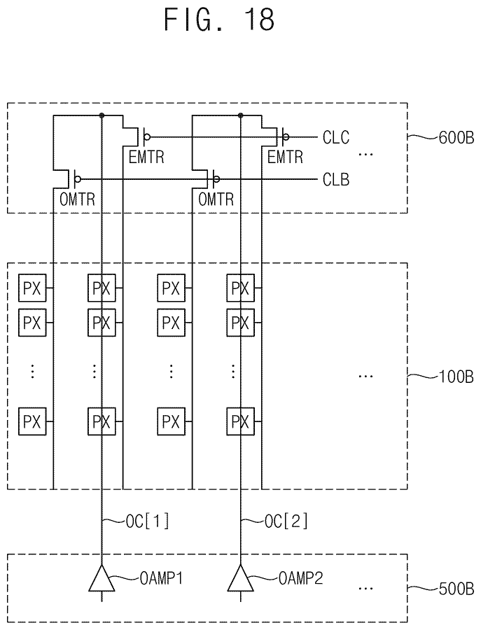

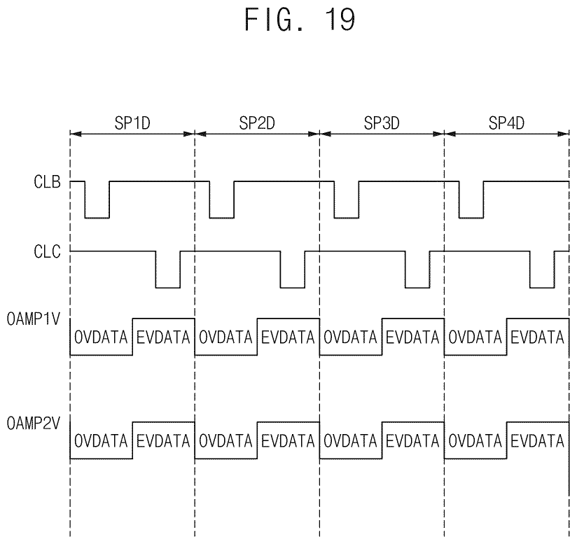

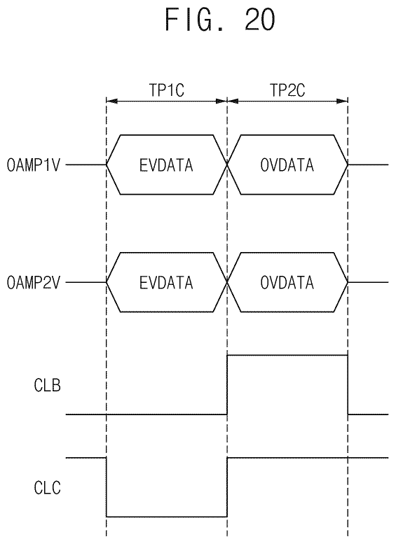

FIG. 17 is a block diagram illustrating an embodiment of a location of a display device 1 of FIG. 1. FIG. 18 is a circuit diagram illustrating an embodiment of a display panel 100B, a data driver 500B and a mux block 600B of FIG. 17. FIG. 19 is a timing diagram illustrating input signals in an active period of a display device 1 of FIG. 1. FIG. 20 is a timing diagram illustrating an embodiment of input signals in an activation period and an inactivation period included in a scan period of FIG. 19.

Referring to FIG. 1 and FIG. 17 to FIG. 20, the display device 1 may include a display panel 100B, a data driver 500B and a mux block 600B. The display panel 100B may include first to 2P-th data lines DLB[1], DLB[2], DLB[3], DLB[4] to DLB[2P-1] and DLB[2P]. The display panel 100B may include the first to P-th output lines OC[1], OC[2] to OC[P]. In an embodiment, the data driver 500B may be connected to the mux block 600B through the first to P-th output lines OC[1], OC[2] to OC[P], for example.

In the illustrated embodiment, the data driver 500B may include the output amplifiers OAMP1 and OAMP2. The output amplifiers OAMP1 and OAMP2 may be connected to the first to P-th output lines OC[1], OC[2] to OC[P]. In an embodiment, the first output amplifier OAMP1 may be connected to the first output line OC[1], for example. In an embodiment, the second output amplifier OAMP2 may be connected to the first output line OC[2], for example. The first output amplifier OAMP1 may output the data voltage VDATA to the first output line OC[1]. The second output amplifier OAMP2 may output the data voltage VDATA to the second output line OC[2].

The mux block 600B may include even-numbered output control transistors EMTR and odd-numbered output control transistors OMTR.

The even-numbered output control transistors EMTR may include a control electrode receiving a first output control signal CLB, a first electrode connected to an output line and a second electrode connected to the even-numbered data line DLB[2P]. The even-numbered output control transistors EMTR may apply the data voltage to the even-numbered data line DLB[2P] in response to the first output control signal CLB.

The odd-numbered output control transistors OMTR may include a control electrode receiving a second output control signal CLC, a first electrode connected to the output line and a second electrode connected to the odd-numbered data line DLB[2P-1]. The odd-numbered output control transistors OMTR may apply the data voltage to the odd-numbered data line DLB[2P-1] in response to the second output control signal CLC.

In the illustrated embodiment, in an active period, the data voltage VDATA may be applied to the pixel circuit of the pixel PX. In an embodiment, the active period may include a first scan period SP1D, a second scan period SP2D, a third scan period SP3D and a fourth scan period SP4D, for example. Each of the first scan period SP1D, the second scan period SP2D, the third scan period SP3D and the fourth scan period SP4D may include a first period TP1C and a second period TP2C.

In the first period TP1C, the data voltage VDATA may have the even-numbered data voltage EVDATA. In the first period TP1C, the output amplifiers OAMP1 and OAMP2 may output the even-numbered data voltage EVDATA, the first output control signal CLB may have an activation level, and the second output control signal CLC may have an inactivation level.

In the first period TP1C, the first output control signal CLB may have an activation level, the even-numbered output control transistor EMTR may be turned on. The even-numbered output control transistor EMTR may be turned on, so that the even-numbered data voltage EVDATA may be applied to the even-numbered data line DLB[2P]. In the first period TP1C, the second output control signal CLC may have an inactivation level, so that the odd-numbered output control transistors OMTR may be turned off.

In the second period TP2C, the data voltage VDATA may have the odd-numbered data voltage OVDATA. In the second period TP2C, the output amplifiers OAMP1 and OAMP2 may output the odd-numbered data voltage OVDATA, the first output control signal CLB may have an inactivation level, and the second output control signal CLC may have an activation level.

In the second period TP2C, the second output control signal CLC may have an activation level, the odd-numbered output control transistor OMTR may be turned on. The odd-numbered output control transistor OMTR may be turned on, so that the odd-numbered data voltage OVDATA may be applied to the odd-numbered data line DLB[2P-1]. In the second period TP2C, the first output control signal CLB may have an inactivation level, so that the even-numbered output control transistors EMTR may be turned off.

In the illustrated embodiment, the data driver 500B may be spaced apart from the display panel 100B in the first positioning direction D1. Additionally, the mux block 600B may be spaced apart from the display panel 100B in the second positioning direction D2. In an embodiment, the data driver 500B may be disposed on a bottom region of the display panel 100B, for example. In an embodiment, the mux block 600B may be disposed on an upper region of the display panel 100B, for example. The data driver 500B may be spaced apart from the display panel 100B in the first positioning direction D1, and the mux block 600B may be spaced apart from the display panel 100B in the second positioning direction D2, so that a bezel of the display device 1 may be reduced. In an embodiment, the bottom region of the display device 1 may be reduced, for example.

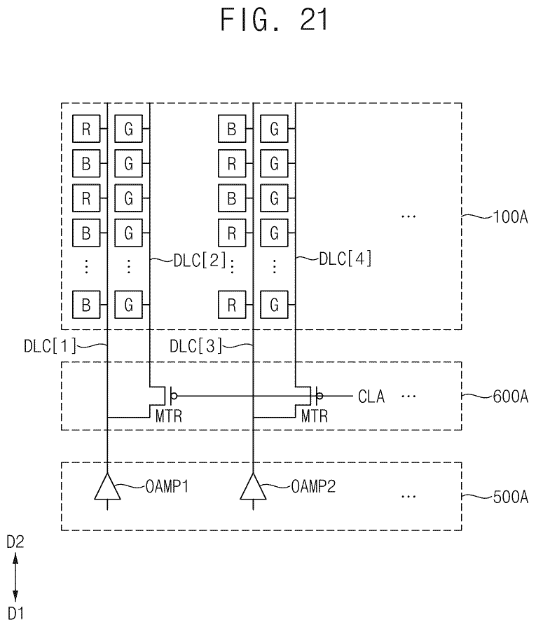

FIG. 21 is a circuit diagram illustrating an embodiment of a location of a display panel 100A and a data driver 500A of FIG. 1 and a mux block 600A.

Referring to FIG. 21, the display device 1 may include a display panel 100A, a data driver 500A and a mux block 600A. The display panel 100A may include data lines DLC[1], DLC[2], DLC[3], DLC[4], . . . , etc.

In the illustrated embodiment, the mux block 600A may be spaced apart from the display panel 100A in the first positioning direction D1. The data driver 500A may be spaced apart from the display panel 100A in the first positioning direction D1.

A circuit diagram of FIG. 21 is substantially same as the circuit diagram of FIG. 4 except that a location of the mux block 600A is different, so that the same reference numerals will be used and any repetitive explanation concerning the above elements will be omitted.

In the illustrated embodiment, the data voltage VDATA applied to the first data line DLA[1] and the second data line DLA[2] may be selected through the first output control transistor. In an embodiment, a data voltage applied to two data lines may be controlled through one transistor, for example. Accordingly, the number of output control transistors included in the mux block 600A may be reduced. The number of output control transistors included in the mux block 600A may be reduced, so that an integration of the mux block 600A may be improved. Accordingly, an integration of the display device 1 may be improved. Additionally, the number of output control transistors included in the mux block 600A may be reduced, so that a power consumption of the display device 1 may be reduced.

Additionally, when the output control transistor MTR is turned on in response to the output control signal CLA, the third color data voltage GVDATA may be applied to the third color pixel G, so that an outputting of the first color data voltage RVDATA and the second color data voltage BVDATA may be stopped. Accordingly, a power consumption of the display device 1 may be further reduced.

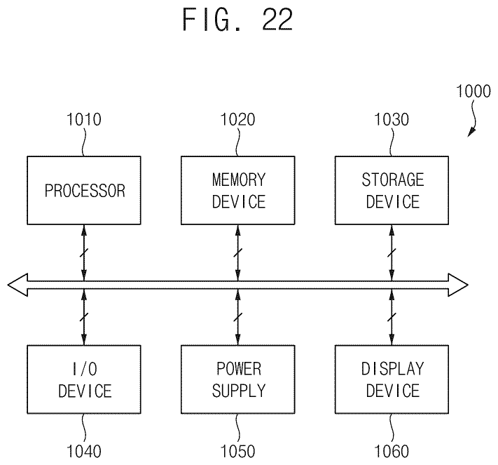

FIG. 22 is a block diagram illustrating an embodiment of an electronic device 1000 according to the inventive concept.

Referring to FIG. 1 to FIG. 22, the electronic device 1000 may include a processor 1010, a memory device 1020, a storage device 1030, an input/output (“I/O”) device 1040, a power supply 1050, and a display device 1060. Here, the display device 1060 may be the display device 1 of FIG. 1. Additionally, the electronic device 1000 may further include a plurality of ports for communicating with a video card, a sound card, a memory card, a universal serial bus (“USB”) device, other electronic device, etc.

In an embodiment, the electronic device 1000 may be implemented as a smart phone. However, the electronic device 1000 is not limited thereto. In an embodiment, the electronic device 1000 may be implemented as a cellular phone, a video phone, a smart pad, a smart watch, a tablet personal computer (“PC”), a car navigation system, a computer monitor, a laptop, a head disposed (e.g., mounted) display (“HMD”) device, or the like, for example.

The processor 1010 may perform various computing functions or various tasks. The processor 1010 may be a micro-processor, a central processing unit (“CPU”), an application processor (“AP”), or the like. The processor 1010 may be coupled to other components via an address bus, a control bus, a data bus, etc. Further, the processor 1010 may be coupled to an extended bus such as a peripheral component interconnection (“PCI”) bus.

The processor 1010 may output the input image data IMG, the input control signal CONT and the mux block control signal MCS to the driving controller 200 of FIG. 1. The processor 1010 may perform data mapping based on the connection structure of the mux blocks 600A and 600B and the display panel 100. The processor 1010 may generate signals for controlling the gate driver 300, the data driver 500, and the mux blocks 600A and 600B.

The memory device 1020 may store data for operations of the electronic device 1000. In an embodiment, the memory device 1020 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, or the like and/or at least one volatile memory device such as a dynamic random access memory (“DRAM”) device, a static random access memory (“SRAM”) device, a mobile DRAM device, or the like, for example.

The storage device 1030 may include a solid state drive (“SSD”) device, a hard disk drive (“HDD”) device, a compact disc read-only memory (“CD-ROM”) device, or the like. The I/O device 1040 may include an input device such as a keyboard, a keypad, a mouse device, a touch-pad, a touch-screen, or the like and an output device such as a printer, a speaker, or the like. In some embodiments, the display device 1060 may be included in the I/O device 1040. The power supply 1050 may provide power for operations of the electronic device 1000. The display device 1060 may be coupled to other components via the buses or other communication links.

The electronic device of the inventive concept is shown implemented as a smartphone, but the inventive concept is not limited thereto. The electronic device may be a television, a monitor, a laptop computer, or a tablet. Additionally, the electronic device may be a car.

The display device in the embodiments may be applied to a display device included in a computer, a notebook, a mobile phone, a smart phone, a smart pad, a portable media player (“PMP”), a personal digital assistance (“PDA”), a motion pictures expert group audio layer III (“MP3”) player, or the like.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the illustrative embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A display device comprising:
a display panel including a plurality of pixels;
a gate driver configured to output a gate signal to the display panel;
a data driver configured to generate a data voltage applied to the display panel; and
a mux block configured to output the data voltage to the display panel, the mux block including:
an output control transistor including:
a control electrode configured to receive an output control signal;
a first electrode connected to a first data line; and
a second electrode connected to a second data line.

2. The display device of claim 1, wherein the data voltage includes a first data voltage and a second data voltage,
wherein the first data line is connected to a first output amplifier of the data voltage, and
wherein the second data line is connected to the first data line through the mux block.

3. The display device of claim 2, wherein in a stated in which the output control signal has an activation level, the data driver outputs the second data voltage.

4. The display device of claim 2, wherein in a stated in which the output control signal has an inactivation level, the data driver outputs the first data voltage.

5. The display device of claim 2, wherein in a stated in which the output control signal has an inactivation level, the first data voltage is applied to the first data line.

6. The display device of claim 2, wherein a length of an activation period in which the output control signal has an activation level is longer than a length of an inactivation period in which the output control signal has an inactivation level.

7. The display device of claim 1, wherein the data driver includes a first output amplifier and a second output amplifier configured to output the data voltage,
wherein the display panel further includes first to fourth data lines disposed sequentially,
wherein the mux block further includes a first output control transistor connected to the first data line and the second data line, and a second output control signal connected to the third data line and the fourth data line,
wherein the first output amplifier is connected to the first data line, and
wherein the second output amplifier is connected to the third data line.

8. The display device of claim 1, wherein the data driver includes a first output amplifier and a second output amplifier configured to output the data voltage,
wherein the display panel further includes first to fourth data lines disposed sequentially,
wherein the mux block further includes a first output control transistor connected to the first data line and the second data line, and a second output control signal connected to the third data line and the fourth data line,
wherein the first output amplifier is connected to the second data line, and
wherein the second output amplifier is connected to the fourth data line.

9. The display device of claim 8, wherein the data voltage includes a first data voltage and a second data voltage, and
wherein in a stated in which the output control signal has an activation level, the data driver outputs the first data voltage.

10. The display device of claim 9, wherein in a stated in which the output control signal has an inactivation level, the data driver outputs the second data voltage.

11. The display device of claim 1, wherein the data driver is spaced apart from the display panel in a first positioning direction, and
wherein the mux block is spaced apart from the display panel in a second positioning direction different from the first positioning direction.

12. The display device of claim 1, wherein the display panel further includes a fordable region and a non-folding region next to the fordable region, and
wherein the mux block is disposed on the fordable region.

13. The display device of claim 12, wherein the non-folding region includes a first non-folding region and a second non-folding region,
wherein the first non-folding region includes a first data line group, and the second non-folding region includes a second data line group,
wherein the first data line group is disposed next to the data driver, and
wherein in a stated in which the output control signal has an activation level, the data voltage is applied to the first data line group and the second data line group.

14. The display device of claim 13, wherein in a stated in which the output control signal has an inactivation level, an operation in which the data voltage is applied to the second data line group is stopped.

15. The display device of claim 14, wherein in a stated in which the output control signal has the inactivation level, the second non-folding region stops emitting.

16. The display device of claim 1, wherein the display panel further includes first to fourth data lines,
wherein the mux block further includes a first output control transistor connected to the first data line and the second data line, and a second output control transistor connected to the third data line and the fourth data line,
wherein a first color pixels having a first color and a second color pixels having a second color different from the first color are connected to the first data line,
wherein a third color pixels having a third color different from the first color and the second color are connected to the second data line,
wherein the first color pixels and the second color pixels are connected to the third data line, and
wherein the third color pixels are connected to the fourth data line.

17. The display device of claim 16, wherein the data driver includes a first output amplifier and a second output amplifier configured to output the data voltage,
wherein the first output amplifier is connected to the first data line and the second output amplifier is connected to the third data line,
wherein in a stated in which the output control signal has an inactivation level, the first output amplifier outputs a first color data voltage, and the second output amplifier outputs a second color data voltage, and
wherein in a stated in which the output control signal has an activation level, the first output amplifier and the second output amplifier output a third color data voltage.

18. An electronic device comprising:
a display panel including a plurality of pixels;
a gate driver configured to output a gate signal to the display panel;
a data driver configured to generate a data voltage applied to the display panel;
a mux block configured to output the data voltage to the display panel, the mux block including:
a first output control transistor including:
a control electrode configured to receive a second output control signal,
a first electrode connected to a first output line; and
a second electrode connected to a first data line; and
a second output control transistor including:
a control electrode configured to receive a first output control signal;
a first electrode connected to the first output line; and
a second electrode connected to a second data line; and
a processor configured to control the gate driver, the data driver and the mux block,
wherein the data driver is spaced apart from the display panel in a first positioning direction, and
wherein the mux block is spaced apart from the display panel in a second positioning direction different from the first positioning direction.

19. The electronic device of claim 18, wherein the data voltage includes a first data voltage and a second data voltage,
wherein a period in which the data voltage is applied includes a first period and a second period,
wherein in the first period, the data voltage has the second data voltage, the first output control signal has an activation level, the second output control signal has an inactivation level, and the second data voltage is applied to the second data line.

20. The electronic device of claim 19, wherein in the second period, the data voltage has the first data voltage, the first output control signal has an inactivation level, the second output control signal has an activation level, and the first data voltage is applied to the first data line.
